(19) United States
(12) Patent Application Publication
(10) Pub. No.: US 2007/0286101 A1
(43) Pub. Date: Dec. 13, 2007

(54) System and method for providing conferencing capabilities

(76) Inventors: Paul Gagne, Groton, MA (US); John R. Corke, Acton, MA (US); Michael L. Bayer, Sudbury, MA (US)

Correspondence Address: IP GROUP OF DLA PIPER US LLP, ONE LIBERTY PLACE, 1650 MARKET ST, SUITE 4900, PHILADELPHIA, PA, 19103, US

(21) Appl. No.: 11/805,459

(22) Filed: May 23, 2007

Related U.S. Application Data
(60) Provisional application No. 60/802,605, filed on May 23, 2006.

(51) Int. Cl. H04L 12/16

(52) U.S. Cl. 370/260

(57) ABSTRACT

A conference system operates to provide conference capabilities for discussion groups that include multiple members. The members provide registration information to identify themselves as well as their communication device. An initiating group member forms groups of registered and unregistered members. When a conference is desired, the initiating group member of a discussion group sends a request to the conference system, which subsequently provides the request to each group member. Group members are validated and joined to the conference without the need of prior coordination or exchange of access codes. Messages may be created and stored for all members of the group or those members unable to participate in the conference. The messages may be controlled by the initiating group member or other members. Members belonging to more than one discussion group having concurrent conferences may participate in all or any desired conferences at the same time.

### CROSS-REFERENCE TO RELATED APPLICATIONS

This application claims priority to U.S. Provisional Patent Application No. 60/802,605, filed May 23, 2006 and entitled “System and Method for Group Voice Communication (aka, Foonz™)”.

### BACKGROUND

Conference calls traditionally allow for members to participate in a group discussion from various remote locations. Typically a conference telephone number and a conference code are provided to each invited member. At a pre-arranged time, invited members may use their telephones to dial the conference telephone number, which connects the members to a conference bridge. The conference bridge operates to link multiple telephone lines, enabling the members to join in the conference with each participating member. Upon connection to the conference bridge, members are prompted to enter the conference code for the desired conference. The conference bridge then connects the member to the conference associated with the entered conference code. Thus, anyone with the conference code may participate in the conference. Securing the conference from uninvited members may not be possible.

In the traditional conference call, coordination is performed by a manager of the conference bridge, such as a conferencing company that specializes in providing conference capabilities. Undesirable limitations arise from the coordination of the conference from an outside party, such as the conferencing company. For example, upon completion of the conference, a mechanism does not exist for timely communication with the invited members who were not able to participate in the conference at the pre-arranged time. For a large conference, it may be difficult to keep track of the members, thus causing a non-participating member to not be noted as not in attendance and therefore not receive an update or overview of the conference. Additionally, if multiple invited members did not participate, then it is time-consuming for one member to individually update each of the non-participating members.

A further limitation arising from the traditional conference system is that coordination must occur prior to the conference start. During this coordination period, several activities must be performed. For example, some conference services require that an organizer must schedule the conference with the conference bridge or company that manages the conference bridge. A pre-arranged time must be decided upon and provided to each invited member with advance notice. Additionally, the conference number and the conference code must be provided to each invited member. This pre-conference coordination does not allow for an effective ad-hoc conference that may need to be held at a moment's notice. It also does not support a spontaneous discussion in order to arrive at a decision that needs to be made by a remote group of individuals.

A further limitation arising from the traditional conference system is that members are granted entry into a single conference at a time. Participants are not able to join more than one conference at the same time. As a result of this limitation, participants are not able to create breakout sessions in an as needed basis.

Accordingly, in light of the above considerations and limitations, an improved conference mechanism is desired.

### SUMMARY

Conference capabilities are provided for discussions groups, each group including multiple members. Each member may be identified by one of many unique communication handles when accessing the conference system using a communication device. Each member may belong to one or more discussion groups, and each member may participate in a conference of the discussion group through any type of communication device. A first member may participate in the conference using a mobile telephone, while a second member may participate in the conference through an audio/video application on a desktop or mobile computer. The members may participate in a different conference with a different communication device. Additionally, members belonging to more than one discussion group having concurrent conferences may participate in all or any desired conferences at the same time.

The conference may be scheduled in advance or may be an ad-hoc conference, in which an initiating member spontaneously decides to establish the conference. The membership of a discussion group may be defined by a group initiator or may be based upon common interest in a topic or theme. Members are immediately notified when a discussion group is initiated and may join the discussion group without using any access code. Membership to topic-based discussion groups is defined dynamically as members access a waiting area of the conference system.

Furthermore, a messaging capability is provided, allowing for the creation, storage, notification, and delivery of messages related to the conference. The conference messages are directed to specific members of the group: all members, those who attended, those who did not attend. Members of the discussion group may reply to the message. Notification of a reply may be sent to all the members of the discussion group. Further, the message initiator may confirm delivery of the message to intended recipients.

### BRIEF DESCRIPTION OF THE DRAWINGS

The foregoing summary and the following detailed description are better understood when read in conjunction with the appended drawings. Exemplary embodiments are shown in the drawings, however, it is understood that the embodiments are not limited to the specific methods and instrumentalities depicted herein. In the drawings:

FIG. 1 is a block diagram representing an exemplary system for providing discussion groups with conference capabilities;

FIGS. 2a and 2b are block diagrams representing exemplary discussion groups;

FIG. 3 is a flow diagram illustrating an embodiment of a method of coordinating discussion groups for conference capabilities among a plurality of members; and

FIG. 4 is a flow diagram illustrating an embodiment of a method of managing multiple conferences among a plurality of members.

### DETAILED DESCRIPTION

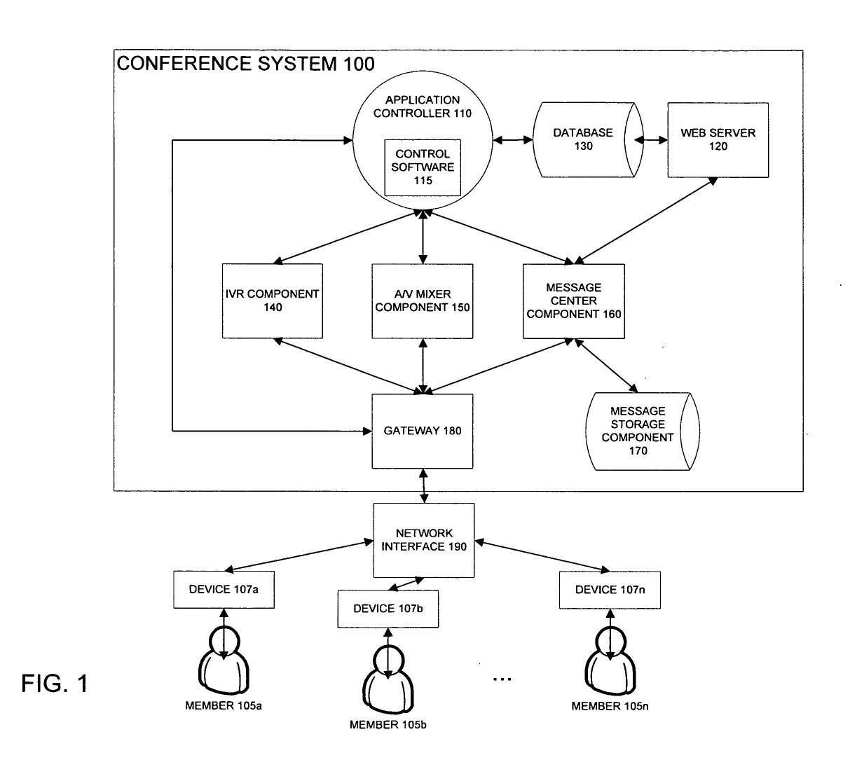

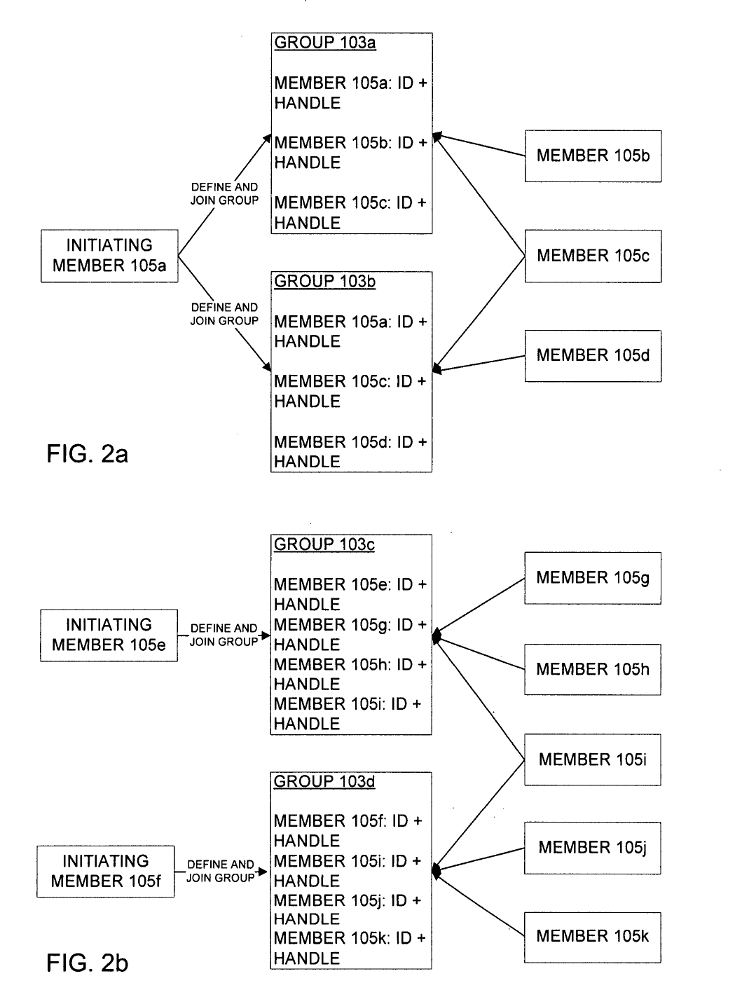

With reference to FIGS. 1, 2a, and 2b, an exemplary conference system 100 for coordinating discussion groups 103 for conference capabilities is shown. A discussion group 103 includes a subset of multiple members 105a-105n, selected by an initiating member 105 to participate in a conference. Members 105a-105n may access the conference system 100 via communication devices 107a-107n. A member 105 is not restricted to one particular communication device 107 and may instead use multiple communication devices 107 for accessing the conference system 100. The communication devices 107 may be, for example, a traditional telephone, a mobile telephone, a desktop computing device, a laptop computing device, or any other communications device capable of connecting to the conference system 100.

To initiate conferences and discussion groups 103, members 105 may register with the conference system 100. During a registration process, a member 105 may participate in an interactive session with the system 100. In the interactive session, the member 105 provides registration information, which may include one, or in the present example, both of a unique member identifier and at least one communication handle, such as a telephone number, an instant messaging (IM) account name, and/or an email address, as examples. Registration may also be performed automatically by the conference system 100 when the member 105 accesses the conference system 100 with a communication device 107. In this case, information, such as the communications handle of the communication device 107, is determined by an application controller 110 of the conference system 100 by the communication device 107 providing its communication handle.

After a member 105 has registered with the system 100, an initiating member 105 may define a discussion group 103 to include multiple members from the members 105a-105n by providing one or more communication handles for each defined member. To participate in conferences and to be included in one or more discussion groups 103, members 105 are not required to be registered with the system 100.

With reference to FIGS. 2a and 2b, exemplary discussion groups 103 are shown. In FIG. 2a, an exemplary discussion group 103a includes an initiating member 105a, member 105b, and member 105c. The initiating member 105a defines, with the conference system 100, the discussion group 103a to include members 105b and 105c. As members 105b and 105c are registered members of the conference system 100, the initiating member 105a is able to define the discussion group 103a using the member identifier of each member 105a, 105b, and 105c. The initiating member may also indicate a group identifier to uniquely portray the discussion group 103a. Included in the definition of the discussion group 103a is at least one of the known communication handles of each member 105a, 105b, and 105c of the group 103a.

The initiating member 105a may further define other discussion groups, such as discussion group 103b, also shown in FIG. 2a. The discussion group 103b is initiated by the initiating member 105a and further includes group members 105c and 105d. Member identifiers are used to create the discussion group 103b, and a group identifier may also be included. Members 105 other than the initiating member 105a may also serve as initiators to establish and create discussion groups 103.

In FIG. 2b, an additional exemplary discussion group scenario is shown. Discussion group 103c, created by initiating member 105e, includes members 105g, 105h, and 105i. Each member 105g, 105h, and 105i is registered with the conference system 100 and possesses a member identifier and at least one communication handle. Also, the discussion group 103c may be assigned a group identifier as chosen by the initiating member 105e. Similarly, discussion group 103d may be created by initiating member 105f to include members 105i, 105j, and 105k. As the member 105i is a member of two distinct discussion groups, the member 105i may participate in simultaneous conferences with the discussion groups 103c and 103d, as will be described in more detail below.

In FIG. 2b, the exemplary discussion group scenario is shown in which one member 105i belongs to two discussion groups (103c and 103d, in this example). Members 105 belonging to more than one discussion group 103 having concurrent conferences may participate in multiple conferences at the same time. A mechanism is provided to determine which discussion groups (103c and 103d, in this example) are available for a member (105i, in this example). A mechanism is provided to join a selected discussion group or groups (103c and 103d, in this example) A mechanism is provided to leave a discussion group (103c, in this example) while remaining in other groups (103d, in this example).

The membership of a discussion group 103 may be defined by a group initiator and may be restricted to those defined in the group definition of the discussion group 103. Membership in a discussion group 103 may also be defined based upon a topic or theme and may be determined dynamically. For example, as members 105 access the conference system 100, members 105 are granted access to a group discussion 103 by selecting a topic of an active discussion group 103. The conference system 100 may determine the topics to present a specific member 105 based upon a comparison of criteria provided by the specific member 105 and criteria entered by an initiating member 105 of a discussion group 103. The member 105 may be an unregistered member.

With reference again to FIG. 1, while an exemplary conference system is shown, it should be understood that other types of conference systems, as well as other suitable hardware and/or software components, may be utilized where desired to accomplish the aspects described herein. As is illustrated in the present example in FIG. 1, an application controller 110 may operate to oversee and coordinate a conference for a discussion group 103, such as the above-described discussion groups 103a-d. The application controller 110 may be a server-based computing device running an operating system. A network stack may operate to interpret control protocol and may provide an application programming interface (API) for interfacing with control software 115. The control software 115 may execute on the application controller 110 and may operate to interpret requests for conferences and coordinate operation of the conference system 100.

In particular, the control software 115 may receive and transmit the registration information for members 105a-105n to register with the conference system 100. The members 105a-105n may provide their respective registration information through their respective communication devices 107a-107n. A network interface 190 may operate as a border between a network of the communication devices 107a-107n and the conference system 100. For example, in a situation where a member 105 is operating a telecommunication device 107, the network interface 190 may be a central office switch, operating to route messages between the telecommunication device 107 and the system 100. In a scenario with an internet protocol (IP) device 107, the network interface 190 may be a session border controller (SBC), acting to determine the destination of communications between the IP device 107 and the system 100. In such a scenario, where an IP network is being accessed, the SBC may further span network edge protection elements, such as firewall devices and network address translation devices.

A gateway 180 may be a network device functioning as an access point to the conference system 100 from the network interface 190. Thus the gateway 180 receives communications from the devices 107a-107n. The gateway 180 operates to process control protocols as well as to trans-code audio and video streams. The gateway 180 may transmit and receive real-time audio and video streams from and to the application controller 110, an interactive voice response (IVR) component 140, an audio/video mixer component 150, and a message center component 160.

The IVR component 140 functions to receive audio prompts and collect touch tone and/or audio responses. The audio/video mixer component 150 acts as a conference bridge, functioning to provide audio and/or video conferencing between the devices 107a-107n.

The control software 115 may further function to receive and transmit discussion group information, such as the creation of a discussion group 103. The discussion group information may include a group identifier as well as member identifiers of the members 105a-105n to be included in the discussion group 103. The discussion group information may be provided to the conference system 100 through a device 107 of a group member 105 acting as a group initiator. The network interface 190 may operate as the border between the conference system 100 and the device 107 of the group member 105 acting as the group initiator.

A further function of the control software 115 may be to initiate a conference for a discussion group 103. The group member 105 acting as a group initiator may contact the conference system 100, through, for example, a telephone number or internet address, and may indicate a request to begin a conference with the discussion group 103. A group identifier may be included in the indication by the initiating member 105. The control software 115 may obtain the group information related to the received group identifier.

A database 130 may be used for the storage of the group information. The database 130 may be a standard, relational database and may contain real-time information related to the group information as well as the member information. The database may organize the discussion groups 103 by group identifiers and may organize the members 105a-105n by member identifiers.

The control software 115, upon receiving a group identifier from the initiating group member 105, may access the database 130 and obtain, from the database 130, the group information. In this manner, the control software 115 has access to the member information related to the discussion group 103 for which a conference is to be initiated, which includes the communication handle of each member 105 of the discussion group 103.

To begin a conference, the control software 115 may contact each member 105a-105n belonging to the discussion group 103 indicated by the group identifier in the request. The contact may be made by using one or more of the known communication handles of each member 105a-105n belonging to the discussion group. The control software 115 communicates with each device 107 of the desired group members 105a-105n through the gateway 180. The gateway 180 interfaces with the network interface 190, which, as described above, may operate to route the communication of a conference with the discussion group 103 to each member 105a-105n. The communication indicating a conference may be in the form of a text message, an email message, an instant message (IM), and/or a voice message, ring tone depending upon the type of device. Alternately, when a member 105a-105n registers with the conference system 100, each member 105a-105n may indicate a communication preference to be used to inform the member 105 of the start of a conference.

If a member 105, from the members 105a-105n, wishes to participate in the conference of the discussion group 103, the member 105 may contact the conference system 100. The form of communication to be used for contacting the conference system 100 may be provided to the member 105 in the conference communication. Alternately, each member 105 may be made aware of a communication mechanism when registering with the system 100. Upon communication with the conference system 100, by, for example, a telephone call, email, or text message, the control software 115 validates the member 105. The validation may include obtaining the communication handle of the member 105, accessing the database 130 to determine the discussion groups 103 to which the member 105 belongs, determining if a conference is in progress for the discussion groups 103 to which the member 105 belongs, and connecting the member 105 to the conference.

The control software 115 may also operate to regulate a number of members 105 participating in the conference. A pre-determined threshold number of members 105 may be established by the initiating group member 105 when creating the discussion group 103 or when initiating the conference. Alternatively, the pre-determined threshold number for the conference may be established by the conference system 100. The control software 115 operates to monitor the number of members 105 participating in the conference and may determine if the number participating exceeds the pre-determined threshold number. If the pre-determined threshold number is exceeded, the control software operates to redistribute the members 105. A new conference may be created for each member 105 attempting to join the conference after the pre-determined threshold has been reached. Any member 105 of the discussion group 103 who subsequently attempts to join the conference will be moved to the new conference. Alternatively, members 105 currently participating in the conference may also be moved to the new conference. The move of members 105 to the new conference may be randomly determined or may be performed based upon parameters established by the initiating group member or based upon pre-determined parameters.

The control software 115 may further operate to provide conference messages to members 105, from the group of members 105a-105n belonging to the discussion group 103, who did not participate in the conference. The control software 115 may determine the participating members 105 by examining the communication handles involved in the conference. By comparing those handles to the handles identified in the group information stored by group identifier in the database 130, the control software 115 may subsequently determine those non-participating members 105. Alternatively, conference messages may be provided to a subset of members 105 of the discussion group 103. The subset may be dynamically determined for the specific discussion group 103. For example, the subset may include all members 105, participating members 105, or non-participating members 105. Other subsets may also be created, such as, for example, a preferred group as indicated by the initiating group member 105.

Conference messages may be created by the initiating group member 105. The conference messages may be in the form of, for example, a text message, an email message, and/or a voice message, depending upon the device 107 used by the initiating group member 105. For example, the initiating group member operating a computer may send an email, text, or instant message to the conference system 100.

The conference messages may typically be provided to the conference system 100 at the conclusion of the conference, but may be provided at other times as well where desired. The control software 115, upon receipt of the conference messages, may then provide the conference messages to the message center component 160. The message center component 160 operates to transmit messages between the control software 115 and a message storage component 170. The message storage component 170 may be a standard, relational database and may contain real-time information related to conference messages. The conference messages may be organized according to discussion group 103. Additionally, the conference messages may also be organized according to predefined parameters. The predefined parameters may be defined by the initiating group member 105 and may include a lifespan of the conference messages and/or an indication to automatically remove the conference messages if the discussion group 103 initiates a second conference and/or an automatic removal of the conference messages based upon a lifespan parameter and the length of the messages, as examples. Another parameter defined may include the topic of the message.

After the creation and storage of conference messages, the initiating member 105 may determine the subset of the discussion group who will receive the message. A message subset includes, but is not limited to, every member 105 of a discussion group 103, participating members 105 of a discussion group 103, non-participating members 105 of a discussion group 103, and/or members 105 who have specified interest in a specific topic. The subset may be dynamically determined for each discussion group 103. For example, one discussion group 103 may wish to provide conference messages to each member 105, while a second discussion group 103 provides a first conference message to non-participating members 105 and a second conference message to all members 105. The conference system 100 may operate to send an indication of a conference message to the members 105 included in the message subset. Alternatively, the members 105 may contact the conference system 100 to request any conference messages.

The conference system 100 may compute statistics related to the conference messages for use by the initiating group member 105. For example, the control software 115 may determine the non-participating members 105 that have accessed the conference messages. This information may be stored in the message storage component 170. The initiating group member 105 may communicate with the conference system 100 and may request the conference message statistics which include, but are not limited to, the members 105 that picked up their message, the time the message was picked up by member 105, and the members 105 that have not picked up their message. The message center component 160 may obtain the statistics from the storage component 170 and may provide the statistics to the initiating group member 105 via the gateway 180 and the network interface 190.

The conference system 100 may further include web servers 120. The web servers 120 may use standard web technology to render HTML pages and access the database 130 to provide a web user interface to members 105. The web servers 120 may communicate with the database 130 and the application controller 110. The web servers 120 update the database 130 with member information as well as discussion group 103 definitions. The web servers 120 also communicate with the database 130 to retrieve state information about current and past discussion groups 103. The web servers 120 may communicate indirectly with the application controller 110. Indirect communication is via the database 130 when the web server 120 places profile and/or state information into the database 130 that triggers a response from the application controller 110.

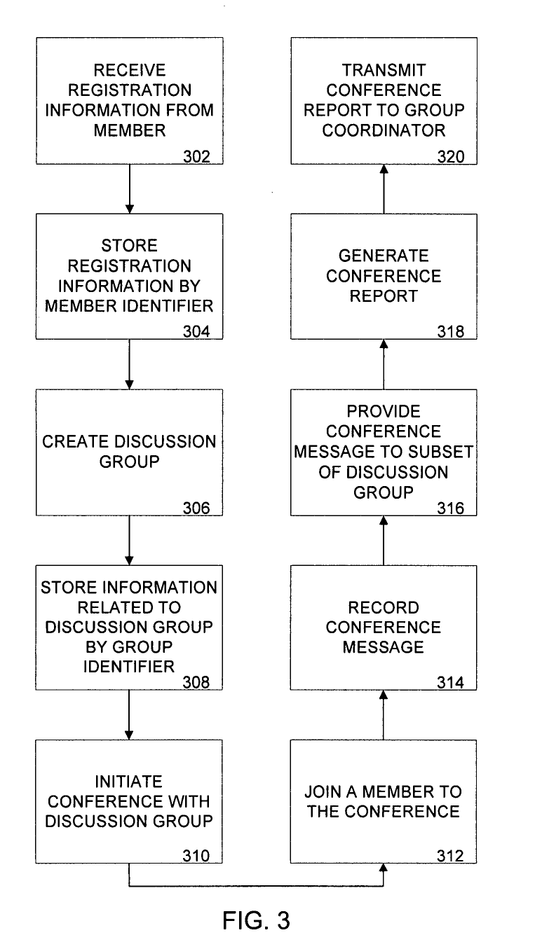

FIG. 3 is a flow diagram illustrating an embodiment of coordinating a conference for a discussion group 103 among a group of members 105. At 302, the conference system 100 receives registration information from members, such as members 105a-105n. The communication devices 107a-107n may be used by the members 105a-105n to provide their respective registration information. The network interface 190 may receive the information from the communication devices 170. The network interface 190 may transmit the information to the gateway 180 for further transmission of real-time audio and/or video streams to the application controller 110. The registration information may include a communication handle for each member 105. The communication handle may be a mobile telephone number, a landline phone number, an instant messaging account, voice over IP handle for a communications session (for example: username@IP_address), and/or an email account. The communication handle may be used to identify a member 105 by identifying the communication device 107 of the member 105. Other identification and/or personal information may be included as part of the registration information.

At 304, the registration information for the members 105 is stored by a unique member identifier. The control software 115, executing on the application controller 110, may provide the registration information to the database 130 for storage and organization of the member identifiers.

At 306, a discussion group 103 is created. The discussion group 103 includes a subset of the members 105a-105n and is identified by a group identifier. The creation of the discussion group 103 may include receiving a creation request to create the discussion group 103 from an initiating group member 105. The initiating group member 105 may access a communication device 107, create a request by, for example forming a telephone message or email message, and transmit the creation request to the conference system 100. The creation request may include the member identifiers corresponding to each member 105 that the initiating member 105 wishes to include in the group 103. The creation request may further include a group identifier, as designated by the initiating group member 105 or assigned by the conference system 100. For example, the database 130 may randomly assign a group identifier to a new discussion group 103.

At 308, group information related to the discussion group 103 is stored in and organized by the database 130. The group information includes the member identifiers of each member 105 in the discussion group 103, as well as the group identifier.

At 310, a conference with the discussion group 103 is initiated. The initiation of the conference may include receiving, at the conference system 100, a conference request as sent by the initiating group member 105. The initiating group member 105, when desiring a conference with the discussion group 103, may create the conference request using the communication device 107 and may transmit the conference request. The conference request may take one of many forms. For example, the conference request may be an interactive voice response script, an email, or a text message from a cellular device. The conference request may include the group identifier of the discussion group 103. The conference request is transmitted from the communication device 170 to the network interface 190, then to the gateway 180, and finally to the application controller 110, for analyzing the conference request and performing the requested function.

The initiation of the conference further includes transmitting, from the conference system 100, a message relaying the conference request to each member 105 of the discussion group 103. When the application controller 110 receives the conference request including the group identifier, the application controller 110 may access the database 130 and obtain the group information related to the group identifier. The group information contains the member identifiers of each member 105 of the discussion group 103. Stored with the member identifiers is the communication handle of each member 105 of the discussion group 103. Thus the application controller 110 is able to transmit the message relaying the conference request to each member by using the communication handles and by formatting the message to be compatible to each communication handle of the group members 105. For example, if member 105a is part of the discussion group 103, the application controller 110 is able to determine that member 105a employs a laptop computer as a communication device 107 to participate in conferences. This knowledge is gained by accessing the group information in the database 130. The application controller 110 may then operate to format the conference request message in an email message, which is a format compatible with the laptop computer of member 105a.

At 312, a member 105 of the discussion group 103 is joined to the conference by the conference system 100. To be joined to the conference, the member 105, upon receiving the conference request message, provides an acceptance stimuli to the conference system 100. The acceptance stimuli may be a telephone call or a text message and may simply indicate that the member 105 wishes to join a conference. The conference system 100, and in particular the application controller 110, determines, from the acceptance stimuli, the discussion group 103 to which the member 105 belongs and connects the member 105 to the conference of the discussion group 103.

To determine the discussion group 103 to which the member belongs, the application controller 110 obtains from the acceptance stimuli the communication handle of the member 105 attempting to join the conference. The communication handle is compared to the various handles stored in the database 130. If the attempting handle matches a stored handle, then the member identifier is obtained, and the database 130 is queried to provide the discussion groups 103 to which that member identifier is included.

At 314, a conference message is recorded. At 316, the conference message is provided to members 105 of a dynamically determined subset of the discussion group. The subset may include the members 105 of the discussion group 103 who did not participate in the conference, the members 105 who did participate in the conference, or all members 105 regardless of their participation in the conference. Other subsets are possible and may be dynamically defined on a discussion group basis. The conference message may be created by the initiating group member 105 and may include highlights or an outline of the conference or any information that the initiating group member 105 wishes to relay. The conference message is created on the communication device 107 of the initiating group member 105 and sent to the conference system 100. The conference system 100 may provide the conference message by transmitting it in a format compatible to the communication handle of each member 105 of the message subset. Alternately or additionally, the conference message may be provided to the members 105 by transmitting an indication of the conference message to each member 105 of the subset. The indication communicates to the members 105 that a conference message is available and provides instructions on how to access the conference message. For example, the indication may inform the members 105 to dial a particular telephone number or access a particular secure website. The conference message may be stored in the message storage component 170.

At 318, a conference report, including conference statistics, may be generated by the application controller 110. The conference statistics may include the length of the conference, the member identifiers of participating members 105, the member identifiers of non-participating members 105, and/or the status of any messages intended to be delivered to any of the members 105. At 320, the conference report is transmitted to a group coordinator, which may be the initiating group member 105 or another group member 105 of the discussion group 103. The conference report is sent in a format compatible to one or more of the known communication handles of the group coordinator, or made available for retrieval by means available to the group coordinator; for example, by voice interface, text message interface, instant message interface, online access through an internet browser connection.

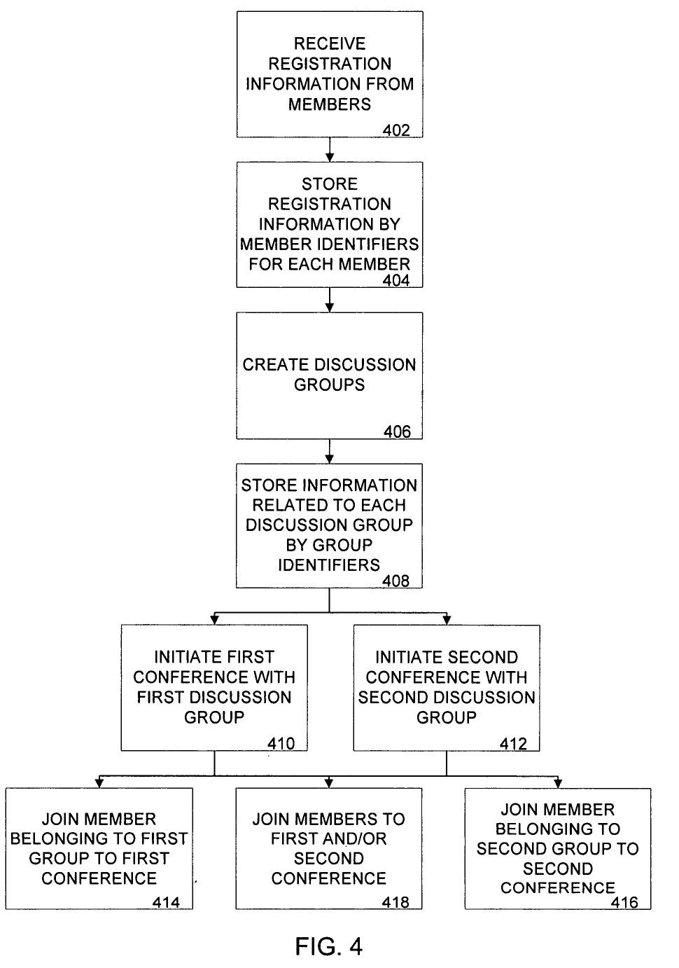

FIG. 4 is a flow diagram illustrating an embodiment of managing multiple conferences among members 105. At 402, the conference system 100 receives registration information from members, such as members 105a-105n. The registration information may include a communication handle for each member 105. The communication handle may be a mobile telephone, an instant messaging account, and/or an email account. The communication handle may be used to identify a member 150 by identifying the communication device 170 of the member 150. Other identification and/or personal information may be included as part of the registration information.

At 404, the registration information for the members 150 is stored by a unique member identifier in the database 130. The control software 115, executing on the application controller 110, may receive the registration information from the communication device 107 of the member 105 and may transmit the registration information to the database 130 for storage and organization of the member identifiers.

At 406, members 105 are organized into multiple discussion groups 103. Each discussion group 103 includes at least one member 105, and each member 105 may belong to more than one discussion group 103. Each discussion group 103 is identified by a group identifier, which may be intentionally selected by an initiating group member 105 or randomly by the conference system 100. Each discussion group 103 is formed by a respective initiating group member 105, who provides a creation request to the conference system 100 via a communication device 107. The creation request may include the member identifiers corresponding to each member 105 that the initiating member 105 wishes to include in the group 103.

At 408, group information related to the discussion group 103 is stored in and organized by the database 130. The group information includes the member identifiers of each member 105 in the discussion group 103, as well as the group identifier.

At 410, a first conference with a first discussion group 103 is initiated. At 412, a second conference with a second discussion group 103 is initiated. The initiation of the first and second conference may occur at the same time. One of the two conferences may begin before the other conference, and one of the two conferences may end before the other conference, but the conferences overlap in time. The conference initiation may be performed as described above with relation to FIG. 3.

At 414, a member 105 belonging to both the first discussion group 103 and the second discussion group 103 is joined to the first conference. At 416, the member 105 belonging to both the first discussion group 103 and the second discussion group 103 is joined to the second conference. The member 105 may be joined to the first conference and the second conference at the same time, or the member may be joined to one conference prior to the other conference.

At 418, other accepted and validated members 105 are joined to the first and/or second conferences depending upon the discussion group 103 memberships. Members may be joined at any time during the duration of the conferences. The conference joining process is described above with relation to FIG. 3.

As is apparent from the above, all or portions of the various systems, methods, and aspects may be embodied in hardware, software, or a combination of both.

The foregoing examples are provided merely for the purpose of explanation and are in no way to be construed as limiting. While reference to various embodiments are shown, the words used herein are words of description and illustration, rather than words of limitation. Further, although reference to particular means, materials, and embodiments are shown, there is no limitation to the particulars disclosed herein. Rather, the embodiments extend to all functionally equivalent structures, methods, and sues, such as are within the scope of the appended claims.

1. A method of coordinating discussion groups for conference capabilities among a plurality of members, the method comprising:
creating a discussion group, wherein the discussion group is comprised of a subset of the plurality of members, wherein each member is identifiable by one or more communication handles for each member, and wherein the discussion group is identified by a group identifier and includes the one or more communication handles for each member;
storing the discussion group by the group identifier; and
initiating a conference without prior coordination with the discussion group;
wherein a member is granted entry into the conference when at least one of the communication handles of the member is identified when the member attempts to join the conference.

2. The method of claim 1, wherein the communication handle comprises one or more of (i) a mobile telephone number; (ii) a landline telephone number; (iii) a voice over IP handle for a communications session; (iv) an instant messaging account; and (v) an email account.

3. The method of claim 1, further comprising:
receiving registration information from each of the plurality of members, wherein the registration information comprises the one or more communication handles for each member; and
storing the registration information for each member by the member identifier.

4. The method of claim 3, wherein receiving the registration information comprises at least one of (i) collecting registration information from a member device of a member when the member device communicates its communication handle; and (ii) collecting the registration information during an interactive session with a member using a member device.

5. The method of claim 1, wherein membership of the discussion group is at least one of (i) defined by an initiating member; and (ii) dynamically determined by allowing membership to a member with specified topics of interest matching a topic of the discussion group.

6. The method of claim 1, wherein creating a discussion group comprises receiving a creation request to create a discussion group, wherein the creation request comprises at least one of the communication handles corresponding to each member of the subset, and wherein the creation request further comprises the group identifier.

7. The method of claim 1, wherein initiating a conference without prior coordination with the discussion group comprises:
receiving a conference request to initiate a conference with the discussion group; and
transmitting a message relaying the conference request to initiate the conference to each member of the discussion group.

8. The method of claim 7, wherein the conference request comprises the group identifier.

9. The method of claim 7, wherein transmitting a message relaying the conference request to initiate a conference comprises transmitting the message in a format compatible to each of the known communication handles of each member of the discussion group.

10. The method of claim 1, further comprising:
joining a member of the discussion group to the conference, comprising receiving from the member an acceptance stimuli to join the conference; determining the discussion group to which the member belongs; and connecting the member to the conference of the discussion group.

11. The method of claim 10, wherein determining the discussion group to which the member belongs comprises:
comparing the communication handle of the member attempting to join the discussion group with the stored discussion group information; and determining if the attempting communication handle matches one or more stored communication handles.

12. The method of claim 10, wherein determining the discussion group to which the member belongs comprises:
comparing selection parameters of the member attempting to join the discussion group with one or more group selection parameters associated with the discussion group; and
determining if the selection parameters of the member matches the group selection parameters.

13. The method of claim 1, further comprising:
recording a conference message;
and providing the conference message to each member of a subset of the discussion group, wherein the subset is dynamically determined for the discussion group.

14. The method of claim 13, wherein providing the conference message comprises transmitting the conference message in a format compatible to the communication handle of each member of the subset of the discussion group.

15. The method of claim 13, wherein providing the conference message comprises:
transmitting a conference message indication in a format compatible to one or more of the communication handles of each member of the subset of the discussion group;
wherein the conference message indication includes instructions on accessing the conference message.

16. The method of claim 1, further comprising:
generating a conference report, wherein the conference report comprises conference statistics; and
providing the conference report to members of the discussion group with access to the conference report.

17. The method of claim 16, wherein providing the conference report comprises transmitting the conference report in a format compatible to the communication handle of the members with access to the conference report.

18. The method of claim 1, wherein each of the plurality of members belongs to multiple discussion groups.

19. The method of claim 1, further comprising:
determining that a number of members joined in the conference has exceeded a pre-determined threshold parameter;
redistributing the members joined in the conference to create a new conference, wherein a subset of the members in the conference are moved to the new conference.

20. A method of managing multiple conferences among a plurality of members, the method comprising:
organizing subsets of the plurality of members into a plurality of discussion groups,
wherein each discussion group includes a subset of the plurality of members, and
wherein each member is a member of at least one discussion group;
storing each of the plurality of discussion groups by a group identifier;
initiating a first conference with a first discussion group;
initiating a second conference with a second discussion group, wherein the second conference overlaps in time with the first conference, and wherein at least one member belongs to the first discussion group and the second discussion group; and
joining at least one member to the first conference and to the second conference.

21. The method of claim 20, further comprising:
receiving registration information from each of the plurality of members, wherein the registration information comprises a communication handle for each member; and
storing the registration information for each member by a member identifier.

22. The method of claim 21, wherein the communication handle comprises one or more of (i) a mobile, telephone number; (ii) a landline telephone number, (iii) voice over IP handle for a communications session; (iv); an instant messaging account; and (v) an email account.

23. The method of claim 20, further comprising:
joining to the first and/or second conferences accepting and validated members belonging to the first and/or second discussion groups.

24. The method of claim 20, wherein initiating a first conference with a first discussion group comprises receiving a first conference request to initiate the first conference with the first discussion group; and wherein initiating a second conference with a second discussion group comprises receiving a second conference request to initiate the second conference with the second discussion group.

25. The method of claim 24, wherein initiating the first conference further comprises transmitting to each member of the first discussion group a message relaying the first conference request in a format compatible to the communication handle of each member of the first discussion group; and wherein initiating the second conference further comprises transmitting to each member of the second discussion group a message relaying the second conference request in a format compatible to the communication handle of each member of the second discussion group

26. The method of claim 20, wherein joining the at least one member to the first conference and to the second conference comprises:
receiving from the at least one member a first acceptance stimuli to join the first conference and a second acceptance stimuli to join the second conference;
determining the discussion groups to which the at least one member belongs; and
connecting the at least one member to the first conference and to the second conference.

27. The method of claim 26, wherein determining the discussion groups to which the at least one member belongs comprises:
comparing the communication handle of the at least one member attempting to join the first conference and the second conference with the stored registration information; and determining if the attempting communication handle matches a stored communication handle.

28. The method of claim 20, further comprising:
allowing the at least one member to navigate between the first conference and the second conference; and
allowing the at least one member to leave the first or second conference while remaining joined to the other of the first or second conference.

29. The method of claim 20, further comprising:
determining that a number of members joined in the first and/or second conference has exceeded a pre-determined threshold parameter; and
redistributing the members joined in the first and/or second conference to create a first new and/or second new conference, wherein a subset of the members in the first and/or second conference are respectively moved to the first new and/or second new conference.

30. A system for providing conference capabilities to discussion groups of a plurality of members, the system comprising:
an application controller comprising control software that operates to:
receive and transmit registration information related to each of the plurality of members, wherein the registration information comprises one or more communication handles for each member;
receive and transmit discussion group information, wherein a discussion group is comprised of a subset of the plurality of members, and wherein a member may belong to one or more discussion groups;
initiate a conference for a discussion group;
a database for storing the registration information and discussion group information;
a message center component for receiving and transmitting conference messages related to the conference; and
a message storage component for storing and organizing the conference messages.

31. The system of claim 30, further comprising:
a gateway network device for communicating with the application controller; and
a network interface for controlling communication between the gateway network device and the plurality of members.

32. The system of claim 31, further comprising:
an interactive voice response component for providing audio prompting between the application controller and the gateway network device; and
an audio and/or video mixing component operating to provide audio and/or video functionality for the conference between the application controller and the gateway network device.

33. The system of claim 30, wherein the message center component directs creation of conference messages by an initiating member of the discussion group for storage in the message storage component for access by designated members of the discussion group.

34. The system of claim 30, wherein the message center component directs creation of conference messages by an initiating member of the discussion group using capabilities of a member device used to create the conference messages.

35. The system of claim 30, wherein the conference messages may be delivered and retrieved by a plurality of message delivery and retrieval devices.

36. The system of claim 30, wherein the application controller determines a sequence of message playback and/or displays; and wherein the sequence may be sorted by topic and sub-sorted by a date and/or time the message was created.

37. The system of claim 30, wherein the message storage component provides access to an initiating member to obtain statistics related to the conference messages.

38. The system of claim 30, wherein the message storage component organizes the conference messages by predefined parameters.

39. The system of claim 38, wherein the predefined parameters of the conference messages comprise a lifespan of the conference messages and automatic removal of the conference messages if the discussion group initiates a second conference.

40. The system of claim 38, wherein the predefined parameters of the conference messages comprise a lifespan of the conference messages and automatic removal of the conference messages based upon the lifespan parameter and the length of a message.

41. The system of claim 30, wherein a message recipient may compose and send a message response to designated members of the discussion group.
